(19) United States
(12) Patent Application Publication
(10) Pub. No.: US 2015/0337106 A1
(43) Pub. Date: Nov. 26, 2015

(54) Low-Melting-Point Glass Resin Composite Material and Electronic/Electric Apparatus Using Same

(71) Applicant: HITACHI, LTD., Chiyoda-ku, Tokyo (JP)

(72) Inventors: Yuri KAJIHARA, Tokyo (JP); Satoru AMOU, Tokyo (JP); Takashi NAITO, Tokyo (JP); Yuichi SAWAI, Tokyo (JP); Motomune KODAMA, Tokyo (JP)

(21) Appl. No.: 14/655,522

(22) PCT Filed: Dec. 26, 2012
(86) PCT No.: PCT/JP2012/083544

§ 371 Date: Jun. 25, 2015

(51) Int. Cl. C08K 3/22

(52) U.S. Cl. CPC C08K 3/22; C08K 2003/2286

(57) ABSTRACT

The purpose of the present invention is to provide a low-melting-point glass resin composite material with which the heat resistance and heat conductivity of an insulating resin can be improved. The low-melting-point glass resin composite material includes: a lead-free low-melting-point glass composition that contains Ag₂O, V₂O₅, and TeO₂, and in which the total content of Ag₂O, V₂O₅, and TeO₂ is 75 mass % or more; and a resin composition having a 5% thermal weight reduction temperature equal to or greater than a softening point temperature of the low-melting-point glass composition.

### TECHNICAL FIELD

The present invention relates to a composite material of low-melting-point glass and resin, and to electronic/electric apparatuse, such as motors, using same.

### BACKGROUND ART

The insulating resins used for electronic/electric apparatuses must satisfy various requirements, including moldability resistance (heat resistance, oil resistance, water resistance), high heat conductivity, adhesion, and moldability. It is known to improve heat resistance by making a highly crosslinked resin chemical structure, and to improve heat conductivity by using a liquid crystalline resin or by increasing the content of a high heat conductivity filler. However, improving the crosslinking of resin lowers the resin flexibility, and increasing the filler content has adverse effects on resin adhesion and moldability. These are all trade-offs.

There accordingly is a need for a technique that can meet the insulating resin requirements, specifically a technique that can overcome the trade-off issue against weather resistance (heat resistance, oil. resistance, water resistance), high heat conductivity, adhesion, and

For example, a material with a high gas barrier property (e.g., glass, oxides) is used to coat a resin and improve the heat resistance of the insulating resin (see PTL 1). PTL 2 describes a class frit and a glass paste with a softening point of 350 to 550° C. for use as sealing material.

### CITATION LIST

### Patent Literature

PTL 1: JP-A-2008-265255

PTL 2: JP-A-2009-214152

### SUMMARY OF INVENTION

### Technical Problem

However, resin materials tend to deter: orate at the glass softening point temperature when an insulating resin is coated with glass to improve the weather resistance (heat resistance, oil resistance, water resistance) of the insulating resin, or when glass is mixed and fused with resin to improve thermal conductivity.

It is accordingly an object of the present invention to provide a low-melting-point glass resin composite material with which the heat resistance and heat conductivity of insulating resins can be improved.

### Solution to Problem

A low-meiting-point glass resin composite material includes:

a lead-free low-melting-point glass composition that contains Ag₂O, V₂O₅, and TeO₂, and in which the total content of Ag₂O, V₂O, and TeO₂ is 75 mass % or more; and a resin composition. having a 5% thermal weight reduction temperature equal to or greater than a softening point temperature of the low-melting-point glass composition.

### Advantageous Effects of Invention

The present invention can improve the heat resistance and heat conductivity of insulating resins.

### BRIEF DESCRIPTION OF DRAWINGS

FIG. 1 represents a chart obtained our the temperature increasing process of a differential thermal analysis (DTA) of a representative glass composition of the present invention.

FIG. 2 is a diagram representing a resin coated with the glass of a low-melting-point glass resin composite material, of the present invention.

FIG. 3 is a diagram showing the glass phase and the resin layer of the low-melting-point glass resin. composite material of the present invention forming a sea-island structure and a bicontinuous phase structure.

FIG. 4 is a diagram representing the stator aid the rotor of an axial gap motor.

FIG. 5 is a diagram representing an axial gap motor stator surface coated with the low-melting-point glass layer of the present invention.

FIG. 6 is a chart representing the results of thermal weight reduction measurements.

FIG. 7 is a diagram concerning activation energy calculation.

### DESCRIPTION OF EMBODIMENTS

The present invention is described below in detail.

### (Glass Composition)

Lowering the characteristic temperatures (e.g., glass transition point, deformation point, and softening point) of lead-free glass composition generally results in deterioration of thermal and chemical stability (for example, the glass becomes more susceptible to crystallization, and the moisture resistance deteriorates). The glass composition of the present invention, despite being substantially lead free, can soften and flow at a firing temperature comparable to or even lower than that of a low-melting-point lead glass (the glass softening point is lowered) while having desirable heat stability and chemical stability.

The lead-free glass composition usable in the present invention is a system that contains at least Ag₂O (silver(I) oxide) V₂O₅ (divanadium pentoxide), and TeO₂ (tellurium dioxide) as main components, and in which the total content of Ag₂O, V₂O₅, and TeO₂ is 75 mass % or more. This makes it possible to make the softening point of the glass 320° C. or less.

The Ag₂O component contributes to lowering the softening point of the lead-free glass composition. The TeO₂ component also contributes to lowering the softening point. The softening point of the lead-free glass composition according to the present invention basically corresponds to the Ag₂O and TeO₂ contents. The V₂O₅ component contributes to inhibiting the precipitation of the metal Ag from the Ag₂O component in the glass, and improving the heat stability of the glass. Because the precipitation of the metal Ag from the Ag₂O component can be inhibited by addition of the V₂O₅ component, the content of the Ag₂O component can be increased to promote lowering the softening point and improve the chemical stability (for example, moisture resistance) of the glass.

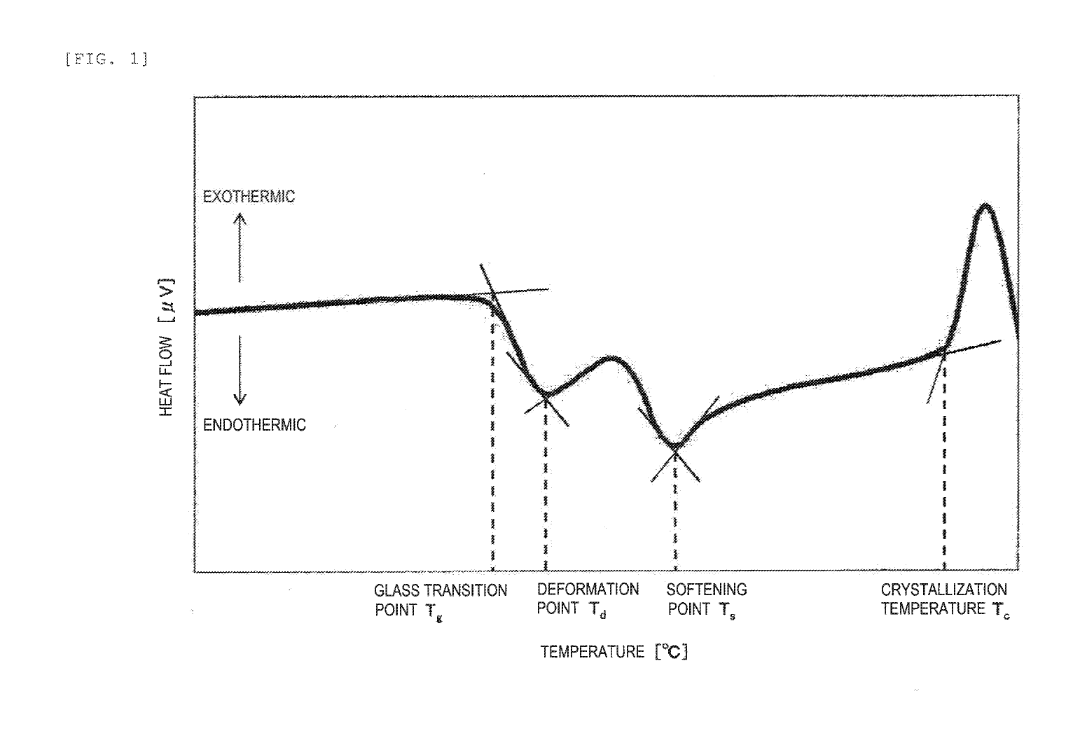

The following defines the glass transition point, the deformation point, the softening point, and the crystallization temperature as used in the present invention. FIG. 1 represents an example of a chart obtained during the temperature increasing process of a differential thermal analysis (DTA) of a representative glass composition of the present invention. The DTA measurement was performed with a reference sample α-alumina at a rate of temperature increase of 5° C/min in the atmosphere. The reference sample and a measurement sample each had a mass of 650 mg. In the present invention, the initiation temperature of the first endothermic peak is defined as the glass transition point. T_{g} (corresponding to viscosity=10^{13.3} poise), the peak temperature of the first endothermic peak is defined as the deformation point T_{d} (corresponding to viscosity=10^{11.0} poise), the peak temperature of the second endothermic peak is defined as the softening point Tₛ (corresponding to viscosity=10^{7.65} poise), and the initiation temperature of the first exothermic peak is defined as the crystallization temperature T_{c}, as shown in FIG. 1. These temperatures are determined by using the tangent method. All characteristic temperatures (for example, softening point. Tₛ) described in this specification follow these definitions.

The glass composition more specifically contains oxide components that are preferably 10 to 60 mass % Ag₂O. 5 to 65 mass % V₂O₅, and 15 to 50 mass % TeO₂, and the total content of Ag₂O, TeO₂, and V₂O₅ is preferably 75 mass % or more. In this way, the softening point of the lead-free glass composition (the peak temperature of the second endothermic peak in the DTA temperature increasing process) can be lowered. to 320° C. or less while ensuring sufficient heat stability.

The firing temperature for making seals under no applied pressure or for forming electrodes/wires with a glass frit or a glass paste using a glass composition is typically about 30 to 50° C. higher than the softening point Tₛ of the glass composition. It is desirable that the firing does not crystallize the glass composition. In other words, the temperature difference between softening point Ts and temperature T_{c} as an index of glass composition heat stability should desirably be about 50° C. or more to form intact seals or electrodes/wires. It should be noted that the firing temperature may be about the same as the softening point is when seals are formed under an applied pressure environment.

The Ag₂O content is preferably smaller than 2.6 times the V₂O₅ content. This ensures a more desirable moisture resistance (a moisture resistance sufficient for practical applications) than those of conventional low-melting-point lead-free glasses. With a Ag₂O content more than 2.6 times the V₂O₅ content, the temperature lowering effect of the Ag₂O component on glass softening point Tₛ becomes smaller, and the glass tends to crystallize.

Further preferably, the sum of the Ag₂O content and the V₂O₅ content is 40 mass % to 80 mass %. In this way, an even higher moisture resistance can be obtained, as will be described later in detail.

Aside from the foregoing compositions, the glass composition according to the present invention may also contain at least one of P₂O₅ (diphosphorus pentoxide) BaO (barium oxide), K₂ (potassium oxide) , WO₃ (tungsten trioxide), MoO₃ (molybdenum trioxide) Fe₂O₃ (iron(III) oxide), MnO₂ (manganese dioxide), Sb₂O₃ (antimony trioxide), and ZnO (zinc oxide) in 25 mass % or less. These additional oxides contribute to improving the moisture resistance or inhibiting the crystallization of the glass of the present invention.

### (Resin Composition)

The resin composition usable in the present invention is not particularly limited, and may be a thermoplastic resin or a thermosetting resin. One basic property desired of the resin is high heat resistance, and the resin composition preferably contains at least one selected from phenol, epoxy, cyanate ester, maleimide, (meth) acrylate, styrene, isocyanate, polystyrene, polyphenylene ether, polyetherimide, polyamide imide, polyether ether ketone, and polyimide. More preferred are phenol, epoxy, and cyanate ester because of their particularly strone molecular bonding. The resin composition may be a blended resin containing at least one of the foregoing components, for example, such as polypropylene/polyethylene polypropylenelpolyphthalamide.

### (Inorganic Filler)

The inorganic filler is contained to inhibit the coefficient of thermal expansion, or to improve strength and heat conductivity. Examples include powders of molten silica, crystalline silica, alumina, zircon, calcium silicate, calcium carbonate, potassium titanate, silicon carbide, aluminum nitride, boron nitride, beryllia, zircon, forsterite, stearite, spirel, mullite, and titania, sheronized beads of these materials, and glass fibers. It is possible with the inorganic filler to improve the hygroscopicity, thermal conductivity, and the strength of epoxy resin cured products using the epoxy resin composition, and to reduce the coefficient of thermal expansion of the products. The inorganic filler is not limited to a particular shape, and may have any shapes such as a sphere, and a scale shape.

The low-melting-point glass resin composite material of the present invention is produced by dispersing the low-melting-point glass composition in the resin composition, molding or curing the mixture, and fusing the glass by a heat treatment conducted at a temperature below the 5% thermal weight reduction temperature of the resin composition.

The glass composition of the present invention may be fused by using a number of methods, including, for example, a method in which a resin composition as a mixture of a powdery glass composition in an uncured liquid resin composition (thermosetting resin) is cured, and the glass composition is fused in the resin by a heat treatment conducted at a temperature below the 5% thermal weight reduction temperature; a method in which a paste prepared by dispersing a powdery glass composition in a solvent is applied onto a pre-molded resin surface, and the glass composition is fused by a heat treatment conducted at a temperature below the 5% thermal weight reduction temperature; and a method in which a glass composition melted at a softening point below the 5% thermal weight reduction temperature is transferred or applied to a pre-molded resin.

Preferred as the solvent used for the paste is butyl carbitol acetate or α-terpineol.

The heat treatment temperature is determined by the relationship between the softening point temperature of the glass composition and the 5% thermal weight reduction temperature of the resin composition. Specifically, there is a preferred composition ratio for mixing the glass composition and the resin composition.

In the present invention, a glass of a preferred composition ratio is a low-melting--point glass composition that contains Ag₂O, V₂O₅, and TeO₂, and in which the total content of Ag₂O, V₂O₅, and TeO₂ is 75 mass % or more. The softening point of the glass composition of this range does not exceed the 5% thermal weight reduction temperature of the resin, and is optimum for mixing the glass composition and the resin composition.

The glass composition used in the present invention also softens by irradiation of light such as a laser beam (400 to 1100 nm), infrared light, and a plasma, and the fusing method is not limited to heat treatment.

The low-melting-point glass resin composite material the present invention has a low-melting-point glass layer in at least a portion of the surface. For example, the glass layer may coat the resin composition surface. FIG. 2 shows a cross sectional view of a resin composition surface coated with a glass layer. In the low-melting-point glass resin composite material of the present invention, the surface portions with the glass layer can have the characteristic weather resistance of the glass.

Oxidative deterioration due to oxygen represents a mechanism of heat deterioration in resin compositions. Such deterioration can be prevented with the glass layer blocking the oxygen contacting surface of the resin composition. The result of blocking the contact between oxygen and the resin surface is the improved resin heat resistance. The resin composition coated with the glass layer can also have improved resistance to oil and water.

The weather resistance improving technique of the present invention does not involve changes in the chemical structure of the resin composition, and can maintain the flexibility of the resin.

Because the glass composition has a softening point below the 5% thermal weight reduction temperature of the resin composition, the resin composition does not undergo heat deterioration, and the glass layer can be molded in a thicker thickness than that by conventional techniques. The interface adhesion between the glass layer and the resin layer is very desirable in the low-melting-point glass resin composite material of the present invention. The Ag₂O in the glass composition forming the glass layer and the inorganic filler component contained in the resin layer have an ionic bonding correlation, and the glass layer and the resin layer strongly adhere to each other at the glass-resin interface.

In the low-melting-point glass resin composite material of the present invention, the glass layer and the resin layer have a sea-island structure or a bicontinuous structure.

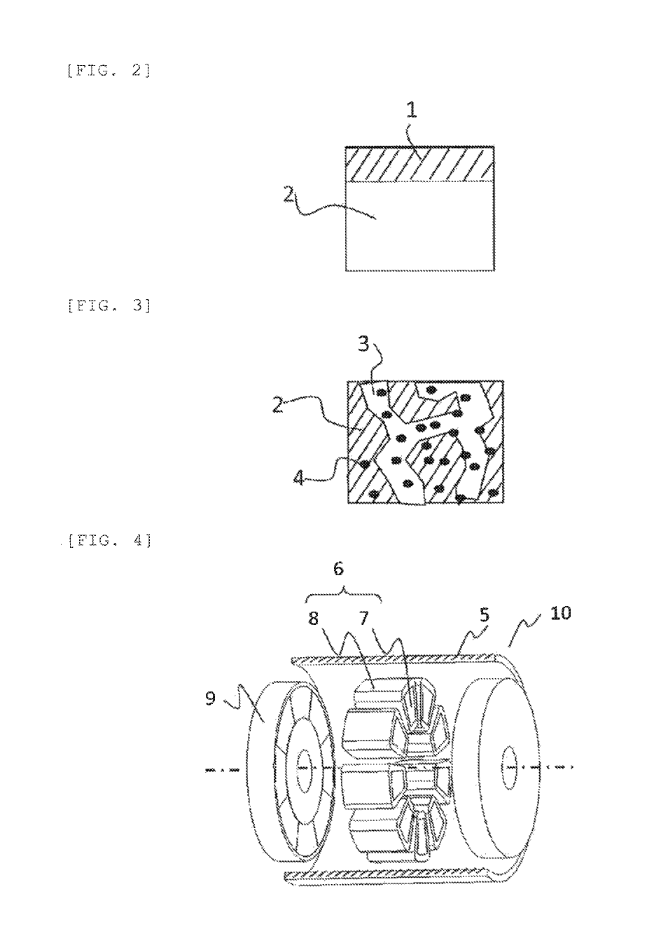

The low-melting-point glass resin composite material of the present invention contains an inorganic filler component. The glass composition becomes a binder for the inorganic filler component, and forms a path upon being melted. (see FIG. 3)

The glass composition used in the present invention has a heat conductivity of about 1 W/m·K, about 2 to 10 times higher than the heat conductivity, 0.1 to 0.5 W/m·K, of typical resin compositions. The inorganic filler component has a heat conductivity of about 1.0 to 50 W/m·K though it varies from one inorganic filler component to another. Heat more easily transfers in the path of the glass layer binding the highly heat conductive inorganic filler component than in the resin layer in which at least the inorganic filler component is dispersed. The heat conductivity of the low-melting-point glass resin composite material of the present invention can thus be increased with the sea-island structure or bicontinuous structure of the glass layer and the resin layer.

The low-melting-point glass resin composite material of the present invention more strongly adheres to metal than the highly heat conductive resin material containing the inorganic filler in high contents. The resin material with the high-content inorganic filler contains less resin component, and becomes less adherent. On the other hand, the glass composition used in the low-melting-point glass resin composite material. of the present invention contains Ag₂O, and has good affinity to metal.

The low-melting-point glass resin composite material of the present invention may be used for the insulating materials and/or structural materials of electronic/electric apparatuses, specifically, for example, molded electrical devices, enamel wires, and heat-resistant adhesive films (heat-resistant wiring films). The low-melting-point glass resin composite material of the present invention may be used for the motor stator of axial gap motors (see FIG. 4)

The motor stator of axial gap motors is molded with an insulating resin. In axial cap motors, the insulating resin serves not only as an electrically insulating material but as a material for maintaining the stator structure. The insulating molded resin needs to maintain sufficient strength for structure retention even in extended use under high temperature conditions (motor operating temperature as high as 130° C.). The surface of the insulating molded resin of the stator is exposed to air, and gradually undergoes oxidative. deterioration under the high temperatures of an operating motor.

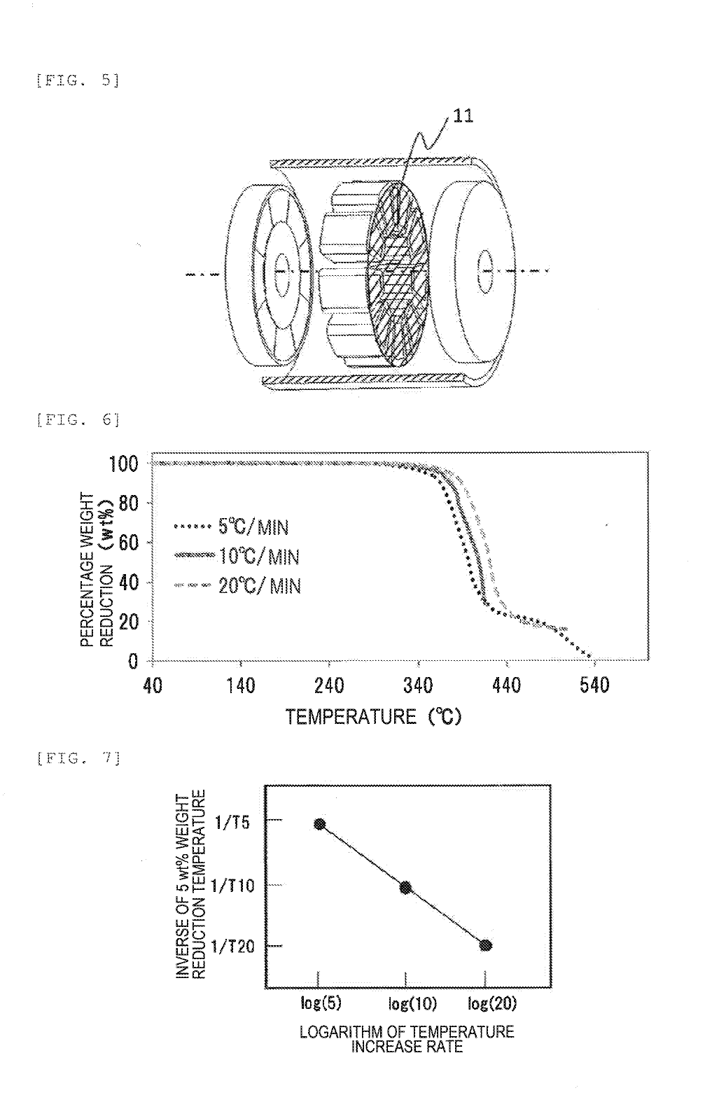

Such oxidative deterioration of the insulating resin can be prevented with the glass composition of the present invention by coating the stator mold surface with the glass composition by using the foregoing methods (see FIG. 5). Examples of such methods include a method in which a paste prepared by dispersing a powdery glass composition in a solvent is applied to a stator molded resin surface, and the glass composition is fused to the stator molded resin surface by a heat treatment conducted at a temperature below the 5% thermal weight reduction temperature; and a method in which a glass composition melted at a softening temperature below the 5% thermal weight reduction temperature is transferred or applied to a stator molded resin surface.

The low-melting-point glass composite material of the present invention may be prepared as a varnish, and may be used in applications such as prepregs, and printed boards. The solvent contained in the varnish is typically an organic solvent. Specific examples include alcohols, ketones, and aromatic compounds. Specific examples of the alcohols usable as the solvent include 2-methoxyethanol, 2-ethoxyethanol, 2-propyloxyethanol, and 2-butoxyethanol. Specific examples of the ketones include methyl ethyl ketone, isobutyl ethyl ketone, cyclohexanone, γ-butyrolactone, and N,N-dimethylformamide. Specific examples of the aromatic compounds include toluene and xylene. These may be used either alone or in a combination of two or more in any proportions A prepreg can be obtained by impregnating a base material with the varnish, followed by drying.

The prepreg can be used for, for example, copper-clad laminates and printed boards, or computers, cell phones, and other electronic devices using these components, various motors with a pregreg-insulated coil unit, and industrial robots and rotary machines using such motors. Other possible applications include chip size packages sealed with the low-melting-point glass resin composite material according to the present embodiment, and adhesives.

Examples are described below with reference to the accompanying drawings.

### EXAMPLE 1

In this Example, low-melting-point glass compositions of various compositions were produced, and used to study the softening point.

### (Production of Glass Compositions)

Glass compositions (AVT 1 to 7) of the compositions presented in Table 1 below were produced. In the table, the content of each component of the compositions is given in mass percent in terms of an oxide. Oxide powders purity 99.9%) available from Kojundo Chemical Laboratory Co., Ltd. were used as starting raw materials. B(PO₃)₂ (barium phosphate, Rasa Industries, Ltd.) was used as the Ba and P source in some of the samples.

The starting raw material powders were mixed in the mass ratio presented in Table 1, and charged into a platinum crucible. An alumina crucible was used when the Ag₂O content in the raw material was 40 mass % or more. The powders were mixed inside the crucible with a metallic spoon to avoid excess moisture absorption by the raw material powder.

The crucible with the mixed raw material powders was installed in a glass melting furnace, and heated and melted therein. The temperature was increased at a rate of 10° C./min, and the glass was maintained for 1 hour with stirring while being melted at a set temperature (700 to 900° C.). The crucible was then removed from the class melting furnace, and the glass was cast into a graphite mold that had been heated to 150° C. beforehand. The cast glass was moved into a straightening furnace that had been heated to a straightening temperature, maintained for 1 hour to remove strains, and cooled to room temperature at a rate of 1° C./min. After being cooled to room temperature, the glass was pulverized to obtain glass composition powders of the compositions presented in Table 1.

TABLE 1

| | | Nominal components of glass composition (mass %) | | | | | | | | | | |
|---|---|---|---|---|---|---|---|---|---|---|---|---|
| Ex./ | Sample | | | | | Other oxides | | | Ag₂O + V₂O₅ + | Ag₂O + | | Glass softening |
| Com. Ex. | No. | Ag₂O | V₂O₅ | TeO₂ | P₂O₅ | BaO | WO₃ | Fe₂O₃ | TeO₂ | V₂O₅ | Ag₂O/V₂O₅ | point Ts (° C.) |
| Ex. 1 | AVT1 | 15 | 10 | 50 | — | — | 15 | 10 | 75 | 25 | 1.5 | 315 |
| | AVT2 | 38 | 17 | 30 | 4.8 | 5.2 | 5 | — | 85 | 55 | 2.2 | 260 |
| | AVT3 | 43 | 17 | 30 | — | 5 | 5 | — | 90 | 60 | 2.5 | 233 |
| | AVT4 | 45 | 20 | 35 | — | — | — | — | 100 | 65 | 2.3 | 208 |
| | AVT5 | 43 | 17 | 40 | — | — | — | — | 100 | 60 | 2.5 | 213 |
| | AVT6 | 43 | 18 | 34 | — | 5 | — | — | 95 | 61 | 2.4 | 221 |
| | AVT7 | 45 | 20 | 30 | — | — | 5 | — | 95 | 65 | 2.3 | 216 |
| Com. Ex. | AVT8 | 35 | 5 | 20 | 20 | — | 20 | — | 60 | 40 | 7.0 | 335 |
| 1 | AVT9 | 40 | 0 | 30 | 5 | — | 25 | — | 70 | 40 | — | 373 |
| | AVT10 | 65 | 0 | 0 | 35 | — | — | — | 65 | 65 | — | 350 |
| | AVT11 | 10 | 45 | 10 | 35 | — | — | — | 65 | 55 | 0.2 | 388 |
| | AVT12 | 0 | 55 | 10 | 35 | — | — | — | 65 | 55 | 0.0 | 404 |
| | AVT13 | 5 | 50 | 0 | 45 | — | — | — | 55 | 55 | 0.1 | 425 |

### (Evaluation of Softening Point)

The glass composition powders obtained as described above were each measured for softening point Tₛ by differential thermal analysis (DTA) The DTA measurements were performed for the reference sample (α-alumina) and measurement samples (650 mg each) in the atmosphere at a rate of temperature increase of 5° C./min, and the peak temperature of the second endothermic peak was determined as softening point Tₛ (see FIG. 1). The results are presented in Table 1.

As shown in Table 1, it was confirmed after DTA evaluations that AVT1 to AVT7 according to the present invention (lead-free glass compositions containing at least Ag₂O, V₂O,, and TeO₂ components in a total content of 75 mass % or more in terms of oxides) had softening points of 320° C. or less.

### EXAMPLE 2

In this Example, the glass compositions AVT1 to VT7 produced. in Example 1. were used to coat resin cured products and produce glass resin composite materials. The produced glass resin composite materials were measured by TGA, and heat. resistance index temperatures were determined from the measurement results.

### (Production of Glass Resin Composite Materials (TGA Measurement Samples))

The glass and the resin cured product was combined in the combinations presented in Table 2. The resin cured product a was produced as follows. A varnish was prepared as a mixture of 100 g of a commercially available epoxy resin Epikote 828 (epoxy equivalent of 190 g; Mitsubishi Chemical Corporation), 87 g of an acid anhydride curing agent 1-1N5500 (Hitachi Chemical Co., Ltd.) and 0.25 g of an imidazole curing promoting agent 2E4MZ-CN (Shikoku Chemicals Corporation), and the varnish was cured at 120° C. for 1 hour and 170° C. for 16 hours. The resin cured product b was produced by curing a commercially available unsaturated polyester EMC, RNC833 (Showa Denko) by transfer molding at. 180° C. for 3 minutes. A polyethylene resin sheet (As One Corporation) was used as The resin cured product c.

The resin cured products were each cut into a 3 mm×3 mm×1 min size, and placed in an aluminum pan for TGA measurement The glass composition (about. 180 mg) was then charged into the pan. The aluminum pan with the resin cured product and the glass composition was placed on a hot plate that had been set to the softening point temperature (208 to 315° C.) of the glass composition, and the glass composition was melted. The glass composition was melted for 1 minute (the aluminum pan was placed on the hot plate for 1 minute). After the 1-min melting time, the aluminum pan was separated from the hot plate, and the glass composition was cured at room temperature to obtain a glass resin composite material as a TGA measurement sample.

### (Estimation of Heat Resistance Index Temperature)

The heat resistance index temperature estimation method is described below. In the present invention, the estimated. heat resistance index temperature is the temperature at which the composition has a 5 wt % weight reduction after 20000 hours under certain temperature conditions.

The weight reduction behavior of each sample was observed under a stream of air (100 mL/min) at rates of temperature increase of 5° C./min, 10° C./min, and 20° C./min in a measurement performed with a TA instruments Q500 thermogravimetric analyzer (TGA). The temperature at which the low-melting-point glass resin composite material had a 5 wt % reduction in the total amount of the resin components except for the filler was then determined. As an example, FIG. 6 represents the observation result for the combination or AVT7 and resin ma. The logarithm of the heating rate, and the inverse of the 5 wt % reduction absolute temperature were plotted on the vertical axis and horizontal axis, restively, by the Ozawa-Flynn-Wall method, and the activation energy was determined from the slope (see FIG. 7) according to equation. (1).

In equation (1), the number 0.4567 represents the coefficient of the approximation formula for deriving the activation energy according to the method of Ozawa described in “Non isothermal Kinetics (1) Single Elementary Process”, Takeo Ozawa, Netsu Sokutei Vol. 31, (3), pp 125-132.

Activation energy(E, Kcal/mol)=slope×1.978/0.4567/1000 Equation (1)

Heat resistance index temperature Ti determined by using Equation (2). In equation (2), ti represents the time to 5 wt % weight reduction, 20000×60 (min); Ha represents the activation energy (value from equation (1)); R represents the gas constant, 8.3122621 (J/K·mol; Vt represents the rate of temperature increase (K/min), Tn represents the temperature at 5 wt % weight reduction (K, observed value in TGA measurement); and Ti. represents the heat resistance index temperature.

=(Ea/VtR)*10^{(-2.315-0.4567*Ea/RTn)}*exp(Ea/RTi)

The heat resistance index temperature of the resin composition alone was also estimated for comparison with the low-melting-point glass resin composite materials.

Table 2 presents the estimated heat resistance index temperatures.

TABLE 2

| | | | Heat resistance |
|---|---|---|---|
| Ex/ | Glass | Resin | index temperature |
| Com. Ex. | sample No. | sample No. | (° C.) |
| Ex. 2 | AVT1 | a | 220 |
| | | b | 115 |
| | | c | 163 |
| | AVT2 | a | 220 |
| | | b | 114 |
| | | c | 163 |
| | AVT3 | a | 221 |
| | | b | 113 |
| | | c | 164 |
| | AVT4 | a | 220 |
| | | b | 114 |
| | | c | 164 |
| | AVT5 | a | 221 |
| | | b | 115 |
| | | c | 164 |
| | AVT6 | a | 221 |
| | | b | 114 |
| | | c | 164 |
| | AVT7 | a | 217 |
| | | b | 115 |
| | | c | 167 |
| Com. Ex. 2 | No glass | a | 165 |
| | coating | b | 73 |
| | | c | 93 |
| | | a | 131 |
| | AVT8 | b | 64 |
| | | c | 74 |

The heat resistance index temperatures shown in The table are average temperatures from the estimation results for the rates of temperature increase of 5° C./ min, 10° g/min, and 20° C./min, because the results were not greatly different for these conditions. As shown. in Table 2, the low-melting-point. glass resin composite materials coated with AVT1 to AVT7 had higher heat resistance index temperatures than the resin alone (Comparative Example 2). It was therefore confirmed that the low-melting-point glass resin composite materials of the present invention improved the heat resistance of the resin.

### EXAMPLE 3

In this Example, glass resin composite materials were produced by heat curing a mixture of the glass composition (AVT1 to 3) of Example 1, a resin, and a filler. The produced glass resin composite materials were each measured for heat conductivity.

### (Production of Glass Resin Composite Materials)

A varnish was prepared by mixing 100 g of a commercially available epoxy resin Epikote 828 (epoxy equivalent 190 g; Mitsubishi Chemical Corporation), 87 g of an acid anhydride curing agent HN 5500 (Hitachi Chemical Co., Ltd.). and 1.87 q of an imidazole curing promoting agent 2E4MZ-CN (Shikoku. Chemicals Corporation). The powdery glass composition was mixed with the varnish in a volume ratio of 20 vol %. An alumina filler was then mixed with the mixture of the glass composition and the varnish in a. volume ratio of 35 vol % to produce the varnish a.

The varnish a was placed in an aluminum cup, and cured at 120° C. for 1 hour, and 200° C. for 3 hours to obtain. a. low-melting-point glass resin composite material.

### (Evaluation of Heat Conductivity)

A 1-cm square test piece was taken out of the produced low-melting-point glass resin composite material, and used for thermal diffusivity measurement e A flush analyzer (NRTZSCH, nanoflash. LEA 447; Brukaer) was used to measure the thermal diffusivity of the cut test. piece,, and the resulting value was multiplied by the measured density obtained by using the Archimedes method, and the specific heat obtained according to the DCS method to determine the heat conductivity in thickness direction. The results are presented. in Table 3.

### (Peel Strength)

A mixed solvent of equal weights of 2-methoxyethanol and methyl ethyl ketone was added to the varnish a to produce a varnish b with a resin content of 50 mass %.

Six sheets of glass cloth measuring 30 cm 30 cm in size and 100 μm in thickness were each impregnated with the vanish b, and the epoxy resin composition was brought to a semi-cured state (B stage) in a 130° C., 8-min environment in a hot air drier. As a result, six nonsticky prepreg sheets with the cured epoxy resin composition varnish were obtained. These six prepreg sheets were laminated, and a 35 μm-thick copper foil was placed on the top and the bottom of the prepreg laminate. The whole laminate was heated to the softening point temperature (208 to 315° C.) of the glass composition. by vacuum press (a rate of temperature increase of 6° C./min), and completely cured (220° C. for 1 hour; C stage) to obtain a defect-free copper-clad laminate.

The copper-clad laminate was cut into 50 mm×100 mm, and the load applied to vertically pull a 10 mm-wide sample of the copper-clad laminate was measured with an autograph (Shimadzu ACT-X). The unit is kN/m. The measurement was performed for three test pieces, and a mean value was taken for evaluation. The autograph was used at a pull, rate of 50 mm/min. The results are presented in Table 3.

TABLE 3

| | | Heat | Peel |
|---|---|---|---|
| Ex./ | Glass | conductivity | strength |
| Com. Ex. | sample No. | (W/m · K) | (kN/m) |
| Ex. 3 | AVT1 | 2.5 | 1.4 |
| | AVT2 | 1.8 | 1.1 |
| | AVT3 | 2.3 | 1.3 |
| Com. Ex. 3 | No glass | 0.7 | 1.1 |

As shown in Table it was confirmed that the low-melting-point glass resin composite materials of the present invention maintained the adhesion, and had improved heat conductivity.

COMPARATIVE EXAMPLE 11

Glass compositions AVT8 to AVT13 were produced, and measured. for softening point temperature In the same manner as in Example 1. The compositions and the results of measuring the softening points are presented. in Table 1.

As shown in Table 1, the PTA evaluation of AVT8 to 13 according to the present invention confirmed that the softening points were 320° C. or more.

### COMPARATIVE EXAMPLE 21

A glass rearm composite material was produced by coating a resin cured product with the glass composition AVT8 produced in Comparative Example 1. The low-melting--point glass resin composite material, was then measured for activation energy and heat resistance index temperature in the same manner as in Example 2.

As shown in Table 2, it was confirmed that the resin composition deteriorates, and the heat resistance index temperature decreases when the resin and the glass are fused under a high glass composition softening point temperature condition, specifically under the condition where the glass composition softening point temperature is higher than the 5% thermal weight reduction temperature of the resin composition.

### REFERENCE SIGNS LIST

1 Low-melting-point glass layer

2 Resin layer

3 Path of low-melting--point glass

4 Filler

5 Housing case

6 Bobbin

7 Electromagnetic steel plate

8 Coil

9 Rotor

10 Axial gap motor

11 Stator surface coated with low-melting-point glass layer

1.-8. (canceled)

9. A low-melting-point glass resin composite material comprising:
a lead-free low-melting-point glass composition that contains Ag₂O, V₂O₅, and TeO₂, and in which the total content of Ag₂O, V₂O₅, and TeO₂ is 75 mass % or more; and
a resin composition having a 5% thermal weight reduction temperature equal to or greater than a softening point temperature of the low-melting-point glass composition,
wherein the low-melting-point glass composition is fused to the resin composition.

10. The low-melting-point glass resin composite material according to claim 9, wherein the resin composition contains at least one selected from phenol, epoxy, cyanate ester, maleimide, (meth)acrylate, styrene, isocyanate, polystyrene, polyphenylene ether, polyetherimide, polyphenylene sulfite, polyamide imide, polyether ether ketone, and polyimide.

11. The low-melting-point glass resin composite material according to claim 9, further comprising an inorganic filler component.

12. The low-melting-point glass resin composite material according to claim 9, wherein the low-melting-point glass composition is dispersed in the resin composition, molded or cured, and subjected to a heat treatment at a temperature below the 5% thermal weight reduction temperature to fuse the glass.

13. The low-melting-point glass resin composite material according to claim 9, wherein the low-melting-point glass resin composite material has the low-melting-point glass composition in a portion of a surface of the resin composition.

14. The low-melting-point glass resin composite material according to claim 9, wherein the low-melting-point glass composition and the resin composition have a sea-island structure and/or a bicontinuous phase structure.

15. An electronic/electric apparatus that uses the low-melting-point glass resin composite material of claim 9 as an insulating material and/or a structural material.

16. The electronic/electric apparatus according to claim 15, wherein the electronic/electric apparatus is an axial gap motor.
